(19) United States
(12) Patent Application Publication
(10) Pub. No.: US 2023/0222847 A1
(43) Pub. Date: Jul. 13, 2023

(54) TASK MANAGING SYSTEM HAVING MULTIPLE TASK EXECUTION CONTROLLERS FOR TESTING-CONFIGURING VEHICLES AND METHOD THEREOF

(71) Applicant: Ford Global Technologies, LLC, Dearborn, MI (US)

(72) Inventors: Jamal Alezzani, Belleville, MI (US); Jason Michael Miller, Woodhaven, MI (US); Priyank Shah, West Bloomfield, MI (US); Basavaraj Tonshal, Northville, MI (US); Richard Moore, Fenton, MI (US); Kerry Lance Paskell, Detroit, MI (US)

(73) Assignee: Ford Global Technologies, LLC, Dearborn, MI (US)

(21) Appl. No.: 17/572,819

(22) Filed: Jan. 11, 2022

(51) Int. Cl. G07C 5/00; G07C 5/08; G06F 9/48

(52) U.S. Cl. CPC G07C 5/008; G07C 5/0816; G06F 9/4887

(57) ABSTRACT

A task managing system for testing and configuring one or more vehicles includes a plurality of task execution controllers. Each of the plurality of the task execution controllers defines a set of communication nodes configured to wirelessly communicate with a set of vehicles of a plurality of vehicles. The task execution controller includes a processor configured to execute instructions stored in a nontransitory computer-readable medium to operate as a task application module configured to execute a task order on a selected vehicle from the set of vehicles by way of a selected communication node from the set of communication nodes. The task order defines one or more software-based tasks to be performed on the selected vehicle

### CROSS-REFERENCE TO RELATED APPLICATIONS

This application is related to copending applications filed concurrently herewith titled “VEHICLE MANAGING SYSTEM FOR MANAGING VEHICLES TO BE TESTED-CONFIGURED AND METHOD THEREOF” and “TASK MANAGING SYSTEM FOR TESTING-CONFIGURING VEHICLES BASED ON A TASK ORDER AND METHOD THEREOF,” which are commonly assigned with the present application and the contents of which are incorporated herein by reference in their entireties.

### FIELD

The present disclosure relates to a system and method for testing and configuring multiples vehicles.

### BACKGROUND

The statements in this section merely provide background information related to the present disclosure and may not constitute prior art.

Vehicles typically go through various testing and system configuration during their life. For example, over the years, vehicle manufacturing facilities have conducted end-of-line diagnostic testing and system configuration on vehicles. To conduct such tasks, a diagnostic tool is physically positioned and located at the end of the manufacturing line and, using a tethered approach, an operator physically plugs the diagnostic testing tool into a connector of a vehicle. Communicating with a vehicle communication network (e.g., local interconnect network (LIN) or a controller area network (CAN)), the diagnostic tool executes tests and software configurations. This approach provides a one diagnostic tool to a one vehicle configuration.

The tethered approach typically provides a limited number of diagnostic tools, which in turn limits the number of vehicles that can be processed during a given period of time. Additionally, due to each tool being physically positioned at the end of the line, the testing and configuration can be limited to the end of the manufacturing line. These issues related to vehicle diagnostics and system configurations, among other issues related to testing and configuring vehicle are addressed by the present disclosure.

### SUMMARY

This section provides a general summary of the disclosure and is not a comprehensive disclosure of its full scope or all of its features.

In one form, the present disclosure provides a method of a task managing system for testing-configuring one or more vehicles. The system includes a plurality of task execution controllers, where each of the plurality of the task execution controllers defines a set of communication nodes configured to wirelessly communicate with a set of vehicles of a plurality of vehicles. Each of the plurally of task execution controllers includes a processor configured to execute instructions stored in a nontransitory computer-readable medium to operate as a task application module. The task application module is configured to execute a task order on a selected vehicle from the set of vehicles by way of a selected communication node from the set of communication nodes. The task order defines one or more software-based tasks to be performed on the selected vehicle.

In some forms, the task managing system further includes a task scheduling controller that is configured to assign the task order to a selected task execution controller from among the plurality of task execution controllers. In some forms, each of the task execution controllers is further operable as a task status module that is configured to monitor a status of the task order being executed, an operation state of the task execution controller, or a combination thereof. The task status module is further configured to generate a status data based on the status of the task order being executed, the operation state of the task execution controller, or the combination thereof, and to transmit the status data to the task scheduling controller. In some forms, the task status module is further configured to determine whether an error has occurred during the execution of the task order and notify the task scheduling controller of the error in response to determining that the error occurred. In response to the error, the task scheduling controller is configured to select another task execution controller from among the plurality of task execution controllers, as the selected task execution controller to execute the task order. In some forms, the task status module is configured to determine, as the error, whether a wireless communication link between the selected communication node and the selected vehicle is abnormal. In some forms, each of the task execution controllers is further operable as a task status module configured to determine an occurrence of a checkpoint of the task order. The checkpoint includes a completed portion of the task order, a completed task order, a determined error, or a combination thereof and generate a report based on the occurrence of the checkpoint. In some forms, the report includes data indicative of a status identifier indicating a progress of the task order, a success rate of the task order, a percentage of completion, a vehicle identification of the selected vehicle, a task execution controller identification, a communication node identification, a request start processing time, a type of status, a report completion time, a task order completion time, an error identifier or a combination thereof. In some forms, the report includes the status identifier indicating a progress of the task order. In some forms, the task application module is configured to assign the selected vehicle to the selected communication node based on availabilities of the set of communication nodes. In some forms, the set of communication nodes are based on user datagram protocol.

In one form, the present disclosure is directed to a method of testing-configuring one or more vehicles by a task managing system including a task scheduling controller and a plurality of task execution controllers. The method includes assigning, by the task scheduling controller, a task order to a selected task execution controller from among the plurality of task execution controllers, and executing, by the selected task execution controller, the task order on a selected vehicle from a set of vehicles by way of a selected communication node from a set of communication nodes. The task order defines one or more software-based tasks to be performed on the selected vehicle, and each of plurality of the task execution controllers defines the set of communication nodes configured to wirelessly communicate with the set of vehicles of a plurality of vehicles.

In some forms, the method further includes monitoring, by the selected task execution controller, a status of the task order being executed, an operation state of the selected task execution controller, or a combination thereof. The method further includes generating, by the selected the task execution controller, a status data based on the status of the task order being executed, the operation state of the selected task execution controller, or a combination thereof, and transmitting, by the selected task execution controller, the status data to the task managing system. In some forms, the method further includes determining, by the selected task execution controller, whether an error has occurred during the execution of the task order, and providing, by the selected task execution controller, a notification of the error to the task scheduling controller in response to determining the occurrence of the error. The method further includes assigning, by the task scheduling controller in response to the error, the task order to another task execution controller from among the plurality of task execution controller, as the selected task execution controller. In some forms, the method further includes determining, by the selected task execution controller, as the error, whether a wireless communication link between the selected communication node and the selected vehicle is abnormal. In some forms, the method further includes determining, by the selected task execution controller, an occurrence of a checkpoint of the task order, and generating, by the selected task execution controller, a report based on the occurrence of the checkpoint. The checkpoint includes a completed portion of the task order, a completed task order, a determined error, or a combination thereof. In some forms, the report includes data indicative of a status identifier indicating a progress of the task order, a success rate of the task order, a percentage of completion, a vehicle identification of the selected vehicle, a task execution controller identification, a communication node identification, a request start processing time, a type of status, a report completion time, a task order completion time, an error identifier, or a combination thereof. In some forms, the report includes a status identifier indicating a progress of the task order. In some forms, the method further includes assigning, by the task scheduling controller, the selected vehicle to the selected communication node based on availabilities of the set of communication nodes.

In one form, the present disclosure provides, a task managing system for testing-configuring one or more vehicles. The system includes a plurality of task execution controllers, in which each of the plurality of the task execution controllers defines a set of communication nodes configured to wirelessly communicate with a set of vehicles of a plurality of vehicles. The system further includes a task scheduling controller configured to assign the task order to a selected task execution controller from among the plurality of task execution controllers. Each of the plurally of task execution controllers includes a processor configured to execute instructions stored in a nontransitory computer-readable medium to operate as, a task application module and a task status module. The task application module is configured to execute a task order on a selected vehicle from the set of vehicles by way of a selected communication node from the set of communication nodes. The task order defines one or more software-based tasks to be performed on the selected vehicle. The task status module is configured to determine an occurrence of a checkpoint of the task order and generate a report based on the occurrence of the checkpoint. The checkpoint includes a completed portion of the task order, a completed task order, a determined error, or a combination thereof. The task scheduling controller is configured to monitor execution of the task order based on the report.

In some forms, the task status module is further configured to determine whether an error has occurred during the execution of the task order and notify the task scheduling controller of the error in response to determining that the error occurred. In response to the error, the task scheduling controller is configured to select another task execution controller from among the plurality of task execution controllers, as the selected task execution controller to execute the task order.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example system in communication with multiple vehicles and devices, accordance with the teachings of the present disclosure;

FIG. 2 is a block diagram of an example task managing system, in accordance with the teachings of the present disclosure;

FIG. 3 is a block diagram of an example block diagram of a task execution controller, in accordance with the teachings of the present disclosure; and

FIG. 4 is a flowchart of an example task execution control routine, in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Vehicles may be equipped with wireless communication devices that establish wireless communication links with external devices that perform diagnostics, tests, software configuration, among other tasks. In a non-limiting example, such a wireless communication link may be based on diagnostic over internet protocol (DoIP). Execution of the various tasks can be challenging due to, for example, the number of vehicles, the different types of vehicles (e.g., make, model, etc.,), the variation in tasks to be performed, among other factors.

The present disclosure provides a system for automatically assigning and executing defined tasks for respective vehicles using wireless communication. More particularly, the system includes a vehicle management system (VMS) for identifying the vehicles and a task managing system (TMS) for executing tasks defined in a task order provided by the VMS. The TMS includes multiple task execution controllers (TEC) that are configured to wirelessly communicate with the vehicles and execute the tasks for a respective vehicle. The system of the present disclosure provides automatic allocation of network resources to execute tasks on multiple vehicles if desired. Additionally, the TMS monitors the execution of the tasks and the health of the communication link between the vehicles and respective TECs to responsively address the issue and reduce or inhibit delays in the execution of the tasks.

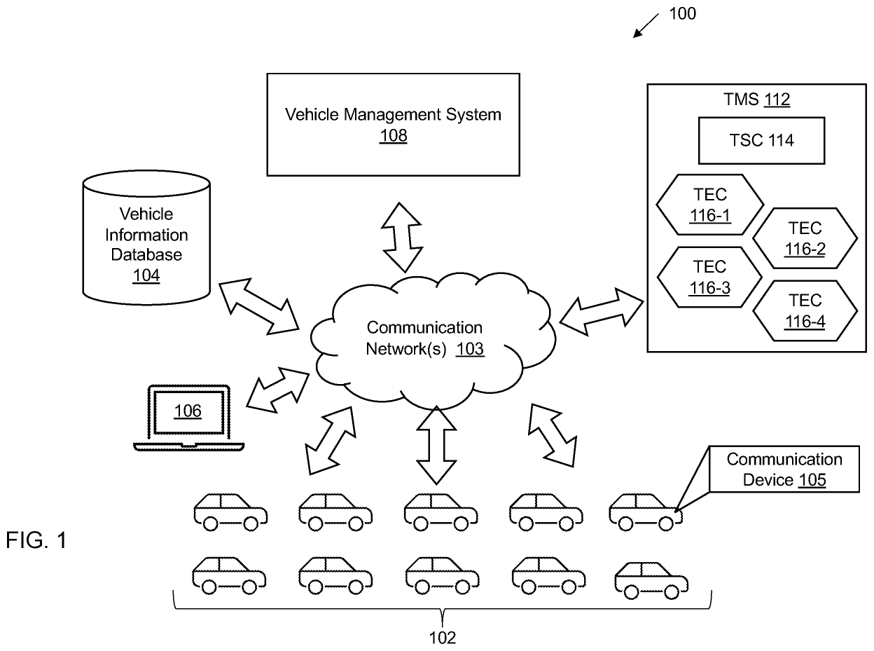

Referring to FIG. 1, the present disclosure provides an example system 100 configured to communicate with one or more vehicles 102 to execute a defined set of software-based tasks on the vehicle 102. In a non-limiting example, the tasks may include vehicle software configuration, vehicle software configuration updates, tests, and/or diagnostics, among other tasks. More particularly, in an example application, vehicles 102 provided in a manufacturing facility are configured to communicate with the system 100. In one form, the vehicles 102 and the system 100 are configured to communicate via one or more communication networks 103 that employs wireless and/or wired communication links. Various wireless communication links may be employed such as, but not limited to, transmission control protocol (TCP), internet protocol(IP), cellular protocols, among others. In a non-limiting example, in using TCP/IP, the vehicles 102 are configured to employ diagnostic over internet protocol (DoIP). Accordingly, the vehicles and the system include software and/or hardware components (e.g., routers, transmitters, microprocessors, antenna, memory, interface ports, among other devices) for establishing the communication link. In addition, the facility may include gateway servers, routers, transmitters, antenna, interface ports, among other components for supporting the communication network 103. It should be readily understood that the system 100 for testing-configuring the vehicles 102 may be employed in other applications, such as at a vehicle service facility, and should not be limited to a manufacturing facility.

In one form, each vehicle 102 includes a communication device 105 that is configured to communicate with external devices via wired and/or wireless communication using one or more of the communication methods described above. The communication device 105 is configured to broadcast an introduction signal that includes data to uniquely identify the vehicle. In a non-limiting example, the data can include a vehicle identifier for the vehicle (e.g., a vehicle identification number (VIN)), an entity identification (EID)), and a communication identification (e.g., IP address). In one form, the communication device 105 is further configured to communicate with other devices/modules within the vehicle 102 via a vehicle communication network (not shown), such as LIN or CAN. Accordingly, the system 100 is able to establish a communication link with the vehicle 102 to manage and execute defined set of tasks for the vehicle, as described herein.

In addition to the vehicle 102, the system 100 is in communication with a vehicle information database 104 that stores information associated with the vehicles 102 via the communication networks 103. More particularly, in one form, the vehicle information database 104 is configured to store the vehicle identifier for each of the vehicles 102 and a corresponding task order for the vehicle. In one form, the task order includes information related to the selected vehicle (e.g., the vehicle identifier, vehicle make, vehicle model, vehicle year, among other information) and one or more tasks to be performed on the vehicle 102.

In one form, a user, such as a technician, may communicate with the system 100 via a computer 106 that is in communication with the system 100 via the communication networks 103. Accordingly, the user is able track the progress of the vehicle 102 and tasks being performed. In addition, the system 100 is able to notify the user of any errors.

In one form, the system 100 includes a vehicle managing system (“VMS”) 108 and a task managing system (TMS) 112. In an example application, the system 100 having the VMS 108 and the TMS 112 include one or more servers provided at the same location or distributed at different locations (e.g., one or more edge computing devices) and communicably coupled accordingly.

When employing wired communication, the system 100 can further include an input-output interface (not show) that provides a wired communication link between the vehicles 102 and the system 100. For example, the input-output interface may be provided as sets of dongles attached to the OBD port of the vehicle 102, where the dongle communicates with the system 100. In another example, the input-output interface is a series of ports to be connected to the vehicle 102 via a cable. The input-output interface is communicably coupled to the VMS 108. In one form, once connected via wired communication, the VMS 108 is configured to identify the vehicle 102, as described herein, and the vehicle 102 may then communicate with the system 100 using wireless communication to have the various tasks performed thereon. In another example, the vehicle 102 and the system 100 including the VMS 108 may communicate only through a wireless communication link.

The VMS 108 is configured to communicate with the vehicles 102 and the TMS 112 to assign the vehicles 102 to the TMS 112, which is configured to perform designated tasks associated with each of the vehicles. An example of such a VMS is disclosed in Applicant's co-pending application titled “VEHICLE MANAGING SYSTEM FOR MANAGING VEHICLES TO BE TESTED-CONFIGURED AND METHOD THEREOF,” which is commonly owned with the present application and the contents of which are incorporated herein by reference in its entirety. As described, the VMS 108 is configured to scan for the introduction signal from the vehicles 102 and identify the vehicle broadcasting the introduction signal, using the vehicle identifier and the information in the vehicle information database 104. The VMS 108 stores and manages an inventory of the data from the vehicles 102, such as the vehicle identifiers and the IP addresses. Once identified and verified, the VMS 108 transmits a message to the TMS 112 to provide data regarding the selected vehicle 102 (e.g., communication address and vehicle identifier) and the task order associated with the selected vehicle 102 to be executed by the TMS 112.

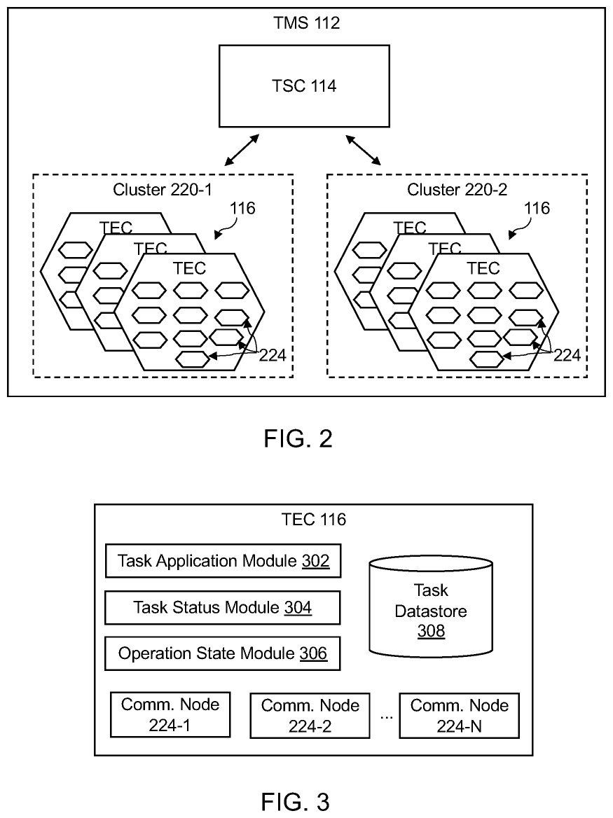

With additional reference to FIG. 2, in one form, the TMS 112 includes a task scheduling controller (TSC) 114 and a plurality of task execution controllers (TEC) 116-1 to 116-4 (collectively “TEC 116”). While four TECs are illustrated in FIG. 1, the TMS 112 may include any number of TECs (i.e., 2 or more). In addition, in an example application, the TECs 116 may be grouped in clusters 220-1 and 220-2 (collectively “clusters 220”), where each cluster 220 includes at least two TECs 116 that are provided in a single machine unit (e.g., a server). In one form, each TEC 116 includes a set of communication nodes 224 (i.e., one or more nodes), where each communication nodes 224 is configured to communicate with a respective vehicle. Thus, a single TEC 116 is able to communicate with multiple vehicles to execute respective task orders for the vehicles 102. In one form, the set of communication nodes are based on user datagram protocol (UDP). It should be readily understood that the depiction of the communication nodes 224 is for illustration purposes only and does not reflect a physical representation of the node 224 as implemented in the TEC 116, for the communication node 224 is a wireless communication port. That is, in a non-limiting example, the communication nodes are provided as a datagram sockets.

In one form, TSC 114 is communicably coupled to the VMS 108 via to acquire the message having information related to the task order and the selected vehicle 102 (e.g., vehicle identifier, communication ID, among other information for identifying and communicating with the vehicle 102). An example of such a TSC is disclosed in Applicant's co-pending application titled “TASK MANAGING SYSTEM FOR TESTING-CONFIGURING VEHICLES BASED ON A TASK ORDER AND METHOD THEREOF,” which is commonly owned with the present application and the contents of which are incorporated herein by reference in its entirety. The TSC 114 assigns the selected vehicle 102 to a selected TEC 116 from among the TEC 116 based on the availability of the TEC 116. For example, the TSC 114 may ping the TECs 116 to request information related to the number of communication nodes 224 available and/or unavailable. Once selected, the TSC 114 transmits a message that includes data related to the task order (e.g., tasks to be executed) and the selected vehicle (e.g., vehicle identifier, communication address) to the selected TEC 116. During execution of the tasks, the TSC 114 is configured to monitor and track the status of the task order being executed based on data from the TECs 116. For example, the TSC 114 may transmit a query to the selected TEC 116 to receive an update message from the TEC 116, as described herein. The TSC 114 is also configured to have the TEC 116 perform quality checks. For examples, the TSC 114 requests the TEC 116 to perform a communication link check with the selected vehicle, by having the TEC 116 ping the selected vehicle 102 and determine a response time of the selected vehicle. If the response time exceeds a predetermined time period, the TSC 114 may have the TEC 116 perform a corrective action such as disconnecting and reconnecting communication with the selected vehicle 102 or reassigning the task order to another TEC 116. The TSC 114 may further receive messages from the TECs 116 regarding faults detected by the TECs, as described herein. Based on the fault detected, the TSC 114 may perform a corrective action such as reassigning the task order being performed to another TEC 116 and notifying a user of the faulty TEC.

Referring to FIG. 3, in one form, each TEC 116 is configured to include a task application module 302, a task status module 304, an operation state module 306, and a task datastore 308 configured to store software programs related to the various tasks to be performed. While each TEC 116 is illustrated as having its own task datastore 308, in some variations a single task datastore 308 may be provided via a separate server that is accessible by the TECs 116. Thus, reducing the complexity of the TEC 116.

Once received from the TSC 114, the task application module 302 is configured to execute the task order for the selected vehicle 102 by way of a selected communication node 224 (i.e., communication nodes 224-1 to 224-N in FIG. 3). Specifically, the task application module 302 selects a communication node 224 based on the availabilities of the set of communication nodes 224. For example, the task application module 302 tracks which communication nodes 224 are available and which are unavailable (e.g., nodes 224 that have been assigned a task order), and selects a communication node from among the available node to perform the received task order.

Once a communication node 224 is selected, the task application module 302 uses the communication address of the selected vehicle 102 to establish a wireless communication link between the selected vehicle 102 and the selected communication node 224. In one form, to execute the task order, each task in the task order may be associated with a unique identifier, and the task application module 302 retrieves the software program associated with the task from the task datastore 308 based on the unique identifier and executes the software program via the wireless communication link.

The task status module 304 is configured to monitor or check the status of the task order being executed by selected communication node(s) 224 and in some forms, transmit an update message to the TSC 114 providing data indicative of the status (i.e., status data). For example, after receiving a query from the TSC 114, the task status module 304 provides status data related, but not limited to: the task(s) being executed; percent completion of the task being executed; results of diagnostic/testing task(s); and/or list of task(s) completed. In another example application, the task status module 304 is configured to determine the status of the task based on checkpoints in the task order. That is, the task order being executed may include checkpoints which identify the completion of a task, completion of a portion of a task, and/or completion of the task order. Accordingly, once a checkpoint is reached, the task status module 304 transmits the update message having the status data to the TSC 114. In yet another example, the task status module 304 periodically transmits the update message to the TSC 114.

In some forms, the task status module 304 is further configured to generate one or more reports providing data related to the task orders executed by the respective TEC 116. For example, the data may include, but is not limited to: a status identifier indicating the task orders being executed by the communication nodes; a success rate of completing the task orders; a percentage of completion of the task orders being executed by the communication nodes; the vehicle identifier(s) of the selected vehicle(s) in communication with the TEC; a TEC identification; a communication node identification; a request start processing time; a type of status; a report completion time, a task order completion time; and/or an error identifier.

The task status module 304 is further configured to determine whether an error has occurred during the execution of the task order and notifies the TSC 114 of the error. For example, as a possible error, the task status module 304 determines whether a wireless communication link between the selected communication node and the selected vehicle is abnormal. As provided above, the communication node 224 may ping the selected vehicle 102 and check the response time of the vehicle. In another example, the error may be related to the execution of the task such that task could not be completed (e.g., software error, timeout error during a diagnostic/testing task being executed).

The operation state module 306 is configured to monitor performance and operation of the respective TEC 116. For example, the operation state module 306 may perform a health check using known software diagnostics to determine, for example, presence of faulty hardware (e.g., faulty circuitry), presence of software errors (e.g., TEC 116 has out of date software), and/or errors related to the operation of the communication node, among other hardware and/or software issues affecting operation of the TEC 116. The operation state module 306 is configured to transmit data to the TSC 114 indicative of the result of the health check. Based on the data, the TSC 114 may not perform a corrective action to address any errors/faults with the TEC 116, such as but not limited to: flagging the TEC 116 as being abnormal and transferring task orders to another TEC 116; and issuing a notification regarding the abnormal TEC 116.

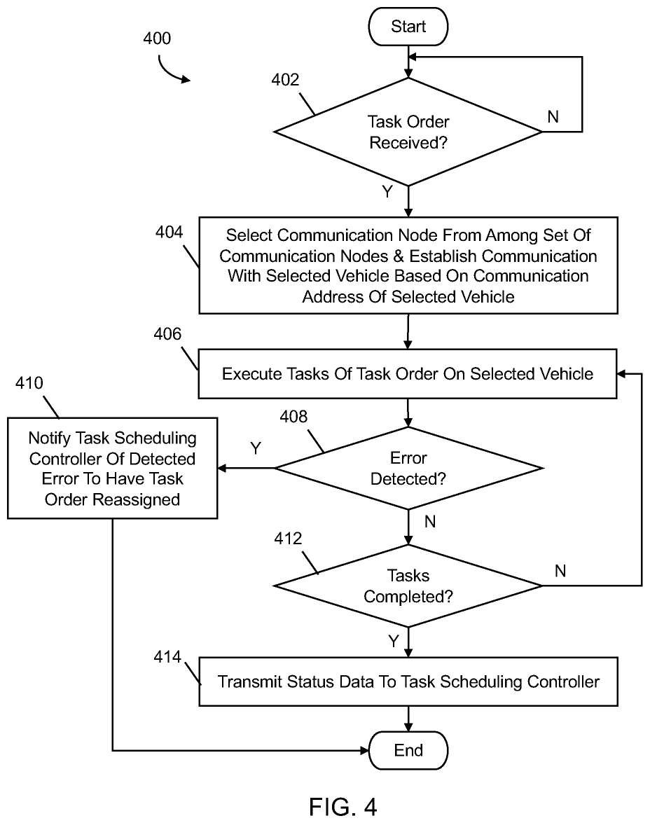

Referring to FIG. 4, an example task execution control routine 400 performed by a given TEC is provided. At 402, the TEC determines whether a task order is received and waits until one is assigned. If a task order is received, the TEC, at 404, selects a communication node from among set of communication nodes and establishes communication with the selected vehicle associated with the task order based on the communication address of the selected vehicle. At 406, the TEC executes tasks of the task order on the selected vehicle, and as the tasks are being executed determines if an error in executing the task(s) is detected, at 408. If an error is detected, the TEC notifies the TSC to have the task order reassigned, at 410. If no error, the TEC determines if the tasks are completed, at 412. If no, the TEC continues to execute the tasks and detect errors. If the tasks are complete, the TEC transmits status data to the TSC providing information related to the tasks executed, at 414. For example, if a diagnostic is performed, the status data includes results of the diagnostic, and if a software configuration is performed, the status data may indicate whether with the software configuration was successfully installed.

It should be readily understood that routine 400 is provided as an example routine and the TEC may be configured in other suitable ways. For example, the TEC is configured to determine occurrence of a checkpoint and transmit status data based on the checkpoint. In addition, the TEC may include other routines for performing health-checks, detecting errors with respect to the communication link between the vehicles and the TEC, among other routines.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A task managing system for testing-configuring one or more vehicles, the system comprising:
a plurality of task execution controllers, wherein each of the plurality of the task execution controllers defines a set of communication nodes configured to wirelessly communicate with a set of vehicles of a plurality of vehicles, wherein
each of the plurally of task execution controllers includes a processor configured to execute instructions stored in a nontransitory computer-readable medium to operate as:
a task application module configured to execute a task order on a selected vehicle from the set of vehicles by way of a selected communication node from the set of communication nodes, wherein the task order defines one or more software-based tasks to be performed on the selected vehicle.

2. The task managing system of claim 1 further comprising a task scheduling controller configured to assign the task order to a selected task execution controller from among the plurality of task execution controllers.

3. The task managing system of claim 2, wherein each of the task execution controllers is further operable as a task status module configured to:
monitor a status of the task order being executed, an operation state of the task execution controller, or a combination thereof,
generate a status data based on the status of the task order being executed, the operation state of the task execution controller, or the combination thereof, and
transmit the status data to the task scheduling controller.

4. The task managing system of claim 3, wherein:
the task status module is further configured to determine whether an error has occurred during the execution of the task order and notify the task scheduling controller of the error in response to the task status module determining that the error occurred, and
in response to the error, the task scheduling controller is configured to select another task execution controller from among the plurality of task execution controllers, as the selected task execution controller to execute the task order.

5. The task managing system of claim 4, wherein the task status module is configured to determine, as the error, whether a wireless communication link between the selected communication node and the selected vehicle is abnormal.

6. The task managing system of claim 1, wherein each of the task execution controllers is further operable as a task status module configured to:
determine an occurrence of a checkpoint of the task order, wherein the checkpoint includes a completed portion of the task order, a completed task order, a determined error, or a combination thereof; and
generate a report based on the occurrence of the checkpoint.

7. The task managing system of claim 6, wherein the report includes data indicative of a status identifier indicating a progress of the task order, a success rate of the task order, a percentage of completion, a vehicle identification of the selected vehicle, a task execution controller identification, a communication node identification, a request start processing time, a type of status, a report completion time, a task order completion time, an error identifier or a combination thereof.

8. The task managing system of claim 7, wherein the report includes the status identifier indicating a progress of the task order.

9. The task managing system of claim 1, wherein the task application module is configured to assign the selected vehicle to the selected communication node based on availabilities of the set of communication nodes.

10. The task managing system of claim 1, wherein the set of communication nodes are based on user datagram protocol.

11. A method of testing-configuring one or more vehicles by a task managing system including a task scheduling controller and a plurality of task execution controllers, the method comprising:
assigning, by the task scheduling controller, a task order to a selected task execution controller from among the plurality of task execution controllers.
executing, the selected task execution controller, the task order on a selected vehicle from a set of vehicles by way of a selected communication node from a set of communication nodes, wherein:
the task order defines one or more software-based tasks to be performed on the selected vehicle, and
each of plurality of the task execution controllers defines the set of communication nodes configured to wirelessly communicate with the set of vehicles of a plurality of vehicles.

12. The method of claim 11 further comprising:
monitoring, by the selected task execution controller, a status of the task order being executed, an operation state of the selected task execution controller, or a combination thereof,
generating, by the selected the task execution controller, a status data based on the status of the task order being executed, the operation state of the selected task execution controller, or a combination thereof, and
transmitting, by the selected task execution controller, the status data to the task managing system.

13. The method of claim 11 further comprising:
determining, by the selected task execution controller, whether an error has occurred during the execution of the task order;
providing, by the selected task execution controller, a notification of the error to the task scheduling controller in response to determining the occurrence of the error; and
assigning, by the task scheduling controller in response to the error, the task order to another task execution controller from among the plurality of task execution controller, as the selected task execution controller.

14. The method of claim 13 further comprising determining, by the selected task execution controller, as the error, whether a wireless communication link between the selected communication node and the selected vehicle is abnormal.

15. The method of claim 11 further comprising:
determining, by the selected task execution controller, an occurrence of a checkpoint of the task order, wherein the checkpoint includes a completed portion of the task order, a completed task order, a determined error, or a combination thereof; and
generating, by the selected task execution controller, a report based on the occurrence of the checkpoint.

16. The method of claim 15, wherein the report includes data indicative of a status identifier indicating a progress of the task order, a success rate of the task order, a percentage of completion, a vehicle identification of the selected vehicle, a task execution controller identification, a communication node identification, a request start processing time, a type of status, a report completion time, a task order completion time, an error identifier, or a combination thereof.

17. The method of claim 16, wherein the report includes a status identifier indicating a progress of the task order.

18. The method of claim 11 further comprising assigning, by the task scheduling controller, the selected vehicle to the selected communication node based on availabilities of the set of communication nodes.

19. A task managing system for testing-configuring one or more vehicles, the system comprising:
a plurality of task execution controllers, wherein each of the plurality of the task execution controllers defines a set of communication nodes configured to wirelessly communicate with a set of vehicles of a plurality of vehicles;
a task scheduling controller configured to assign the task order to a selected task execution controller from among the plurality of task execution controllers, wherein
each of the plurally of task execution controllers includes a processor configured to execute instructions stored in a nontransitory computer-readable medium to operate as:
a task application module configured to execute a task order on a selected vehicle from the set of vehicles by way of a selected communication node from the set of communication nodes, wherein the task order defines one or more one or more software-based tasks to be performed on the selected vehicle, and
a task status module configured to determine an occurrence of a checkpoint of the task order and generate a report based on the occurrence of the checkpoint, wherein the checkpoint includes a completed portion of the task order, a completed task order, a determined error, or a combination thereof, and
the task scheduling controller is configured to monitor execution of the task order based on the report.

20. The task managing system of claim 19, wherein:
the task status module is further configured to determine whether an error has occurred during the execution of the task order and notify the task scheduling controller of the error in response to the task status module determining that the error occurred, and
in response to the error, the task scheduling controller is configured to select another task execution controller from among the plurality of task execution controllers, as the selected task execution controller to execute the task order.
